(19) United States
(12) Patent Application Publication
(10) Pub. No.: US 2012/0236989 A1
(43) Pub. Date: Sep. 20, 2012

(54) Portable XRF analyzer for low atomic number elements

(76) Inventor: Peter John Hardman, Woburn, MA (US)

(21) Appl. No.: 13/065,174

(22) Filed: Mar. 16, 2011

(51) Int. Cl. G01N 23/223

(52) U.S. Cl. 378/45

(57) ABSTRACT

A portable XRF analyzer includes a pressure measurement device disposed to measure the ambient air pressure and a processing subsystem responsive to a detector subsystem and the pressure measurement device. The processing subsystem is configured to calculate the concentration of at least one low atomic number element in the sample based on the intensity of the x-rays detected by the detector subsystem at an energy level corresponding to the element. The intensity value is corrected based on the ambient air pressure. An XRF method is also disclosed wherein the concentration of an element is determined automatically by taking into account the barometric pressure.

### FIELD OF THE INVENTION

This invention relates generally to portable x-ray fluorescence (XRF) analyzers.

### BACKGROUND OF THE INVENTION

Portable XRF analyzers are used to detect elements present in a sample. A typical portable XRF analyzer includes an x-ray source for directing x-rays to the sample and a detector responsive to the x-rays emitted from the sample. An analyzer processes the output signals produced by the detector and divides the energy levels of the detected x-ray photons into several energy subranges by counts of the number of x-ray photons detected to produce a graph depicting the x-ray spectrum of the sample. The intensity at different energy levels corresponds to concentrations of different elements.

Portable XRF analyzers are known. See, e.g., the applicants' co-pending applications, U.S. patent application Ser. No. 11/582,038 filed Oct. 17, 2006 entitled “XRF System with Novel Sample Bottle”, and U.S. patent application Ser. No. 11/585,367 filed Oct. 24, 2006 entitled “Fuel Analysis System”, by one or more common inventors hereof and all of the same assignee, incorporated by reference herein. See also U.S. Pat. Nos. 6,501,825; 6,909,770; 6,477,227; and 6,850,592, all of which are incorporated by reference herein. Using a portable XRF analyzer, an operator can detect whether certain elements are present in a sample for use in such applications as, inter alia, alloy, ores and mineral analysis, security and law enforcement, environmental applications, artistic and historic works, biomedical and pharmaceutical applications, process chemistry, and the like. Another key use of portable XRF analyzers is to detect elements listed by the United States Consumer Products Safety Commission (CPSC) such as lead in toys and coatings, and the European Union Directive Restriction on the Use of Certain Hazardous Substances (RoHs). This Directive restricts the use of certain hazardous substances, such as lead (Pb), mercury (Hg), cadmium (Cd), chromium (Cr) and Bromine (Br), and the like, in manufactured electrical and electronic equipment.

Traditionally, it was difficult to analyze the low energy x-rays emitted by the atoms of elements having lower atomic numbers, e.g., elements between sodium (Na) and chlorine (Cl). This is because the lower energy of these x-rays is typically absorbed by the ambient atmosphere (e.g., air) or the material itself. The argon that is naturally present in the air is also fluoresced very efficiently and creates a source of background noise in the same region of the spectrum where some of these low atomic number elements like S and Cl are being measured. Until recently, in order to accurately analyze and detect these lower atomic number elements, the air between the analyzer window and the detector must be removed. This is done either by creating a vacuum or performing a helium (He) purge whereby the helium displaces the air between the analyzer window and the detector. The vacuum or the purge condition prevents the lower energy x-rays from being absorbed into the ambient atmosphere and increases the sensitivity of the XRF analyzer. See U.S. Patent Publication Nos. US 2008/0152079A1 and 2007/0269003 incorporated herein by this reference. In the later reference, there is a pressure sensor and a temperature sensor in the vacuum chamber for determining the density of the air inside the vacuum chamber. A small vacuum pump is used and readings are corrected based on different pressures in the vacuum chamber.

However, recent improvements in detector technologies including the advent of silicon drift detectors (SDDs) in portable XRF devices have allowed for the accurate measurements of low atomic number elements without the need for a vacuum or purge condition. The SDD technology can count at typically 10× higher rates, and have lower intrinsic noise. These detector improvements offset the air absorption problems mentioned previously and thus allow low atomic number elements to be measured more effectively in ambient conditions, i.e. without the need for vacuum or purge conditions. It remains true, however, that using a purge or vacuum condition that removes the intervening air does improve the quality of the analysis even when an SDD detector is employed. Several manufacturers of portable XRF devices now offer commercial portable XRF devices that measure the low atomic number elements with SDD detector technology using only an ambient air environment between the sample window and the detector and/or x-ray source.

### BRIEF SUMMARY OF THE INVENTION

A significant problem remains in the use of portable XRF analysis for low atomic number elements in ambient conditions. For the measured x-rays from Na (Z=11) to Ti (Z=22) and, in particular, for important alloy elements such as Mg, Al and Si which are very low in energy, the number of x-rays that travel from the sample to the detector vary based on the ambient air pressure. This is because higher or lower the ambient air pressure means more or less air molecules that can absorb the low energy x-rays from a low atomic number element. The concentration of low atomic number elements reported is proportional to the number of x-rays fluoresced and detected from each low atomic number element in the sample. For example, the reported concentration for Mg is proportional to the number of Mg x-rays detected from the sample. An increase or decrease in air pressure relative to the air pressure at time of factory calibration means that fewer Mg x-rays are detected (for increased air pressure relative to the air pressure at the time of calibration) or more Mg x-rays are detected (for decreased air pressure relative to the air pressure at the time of factory calibration). This means that the reported results for Mg will vary depending upon the local air pressure, thus creating systematic errors in the reported results.

Portable XRF units are typically calibrated at a specific geographical location, usually at the factory, and are therefore subject to only small variations in pressure. They are then used in a variety of climates and geographies where variations in ambient air pressure occur. In some cases, portable XRF units are taken to higher elevations, in the mountains, where the ambient air pressure is substantially lower. In other cases, portable XRF units can be taken hundreds or thousands of feet underground at a mine site. In all these cases, the actual local air pressure can be vastly different from the air pressure at the time of calibration. It is also true that even mild variations in barometric pressure, for example, a low pressure weather front, will affect the measured intensities of the lowest atomic number elements. Portable XRF analyzers are used because they provide fast, accurate quantitative results in the field. It is simply impractical to expect operators to perform manual corrections or recalibrations for changes in barometric pressure due to weather or altitude.

An object of this invention is to provide an improved portable XRF analyzer and such an analyzer which provides an ambient air pressure measurement that is reported to the XRF processor in order to correct the results for low atomic number elements in the field in order to account for the effects of altitude or local barometric pressure. The operator need not correct results or recalibrate the portable XRF unit at the local barometric conditions due to the effects of air pressure on low atomic number elements.

The subject invention, in part, results from the realization that, in one embodiment, an improved portable XRF analyzer automatically corrects results for low atomic number elements by the use of an on-board barometer to yield superior analytical data especially now that it is commercially feasible to employ an SDD to measure these elements without the use of a vacuum or purge condition. A detector behind a window is responsive to the x-rays radiated from the sample. A processor responsive to the detector analyzes the spectrum of emitted x-rays to detect the low atomic number elements and is responsive to a barometric sensor that detects a pressure change at the analyzer and automatically corrects the reported results.

A very compact, low power barometer such as the model MPL115A manufactured by Freescale Semiconductor can be mounted inside a portable XRF device. The barometer measures air pressure independent of type of gas or humidity and reports the value digitally to a processor. The portable XRF device can use the locally measured air pressure at any time and the measured air pressure at the time of calibration to make corrections to the measured intensities of the low atomic number elements for any given measurement. Thus, the reported concentrations for the low atomic number elements are corrected automatically by the portable XRF device for any climate or altitude.

The subject invention features, in one example, a portable analyzer comprising an x-ray source configured to emit x-rays to a sample and a detector subsystem responsive to x-rays irradiated by the sample and outputting the intensities of x-rays detected at different energy levels. A pressure measurement device is disposed to measure the ambient air pressure. A temperature sensor is also typically included. A processing subsystem is responsive to the detector subsystem and the pressure measurement device and is configured to calculate the concentration of at least one low atomic number element in the sample based on the intensity of the x-rays detected by the detector subsystem at an energy level corresponding to the element. The processing subsystem corrects the intensity based on the ambient pressure and temperature.

The detector subsystem typically outputs an intensity I for a known concentration of an element at a calibrated pressure P_{c}. The processing subsystem then increases the intensity when the gas pressure is greater than P_{c} and decreases the intensity when the gas pressure is less than P_{c}. Further included may be stored calibration data (curves or formulas) including at least, for one low atomic number element, an intensity level for a known concentration of the element at a known gas pressure. The processing subsystem is then configured to correct the intensity based on the stored calibration data. In one preferred embodiment, the detector subsystem includes a silicon drift detector and the pressure measurement device is a barometer. A temperature sensor may also be included and used to correct the pressure output by the barometer.

The processor is preferably configured to correct the measured pressure based on the measured temperature by correcting the measured pressure based on the measured temperature and a calibration temperature, to correct the intensity by determining a difference between the corrected pressure and a calibration pressure and using the difference to correct the intensity, and to determine a correction factor which is a function of a constant and the difference correction factor for each element may be empirically determined for a known excitation energy.

A commercial analyzer includes a housing about the x-ray source and the detector subsystem. The housing includes a window through which the x-rays pass to and from the sample. The pressure measurement device is disposed in the housing.

The subject invention also features an XRF analysis method comprising emitting x-rays to a sample, detecting x-rays irradiated by the sample, and measuring the intensities of x-rays detected at different energy levels. The ambient air pressure is measured. The concentration of a typically low atomic number element in the sample is automatically calculated based on the intensity of the x-rays detected at an energy level corresponding to the element. The intensity value is then automatically corrected based on the ambient air pressure before the concentration is calculated.

For an intensity I measured for a known concentration of an element at a calibrated pressure P_{c}, correcting includes increasing the intensity when the gas pressure is greater than P_{c} and decreasing the intensity when the gas pressure is less than P_{c}.

The method may further include storing calibration data including at least, for one element, intensity levels for a known concentration of the element at a different gas pressure. Correcting the measured intensity then includes basing the correcting on the stored calibration data. Temperature information can be used to correct a measured pressure.

This invention also features an XRF analysis method including using an XRF analyzer to induce fluorescence in a calibration sample with a known concentration of an element at a known calibration pressure and temperature. Detecting the fluorescence and storing count rates for the element at the known pressure and temperature in the XRF analyzer. The XRF analyzer is then used to induce fluorescence in a field sample with an unknown concentration of the element at ambient pressure and temperature. The fluorescence is detected and a count rate for the element is determined. The ambient pressure and temperature are measured and the determined count rate is corrected based on the ambient pressure and temperature and the stored count rates for the element at the calibration pressure and temperature.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a block diagram depicting the primary components associated with an embodiment of a portable XRF analyzer in accordance with the subject invention;

FIG. 2 is a graph showing several detected sample elements categorized by the fluorescence energy level and the intensity in counts per second;

FIG. 3 is a graph showing how the intensity level for a given element changes as the ambient air pressure changes;

FIG. 4 is a flow chart depicting the primary steps associated with the programming of the processing subsystem shown in FIG. 1 and also showing the primary steps associated with a method of XRF analysis in accordance with the subject invention;

FIG. 5 is a schematic three-dimensional front view showing an example of a handheld XRF analyzer embodying the subject invention;

FIG. 6A-6D are graphs showing X-ray intensity in counts per second as a function of pressure (mbar) for four different elements; and

FIG. 7 is a more detailed flow chart depicting the operation of the software operating on the processing subsystem of FIG. 1.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

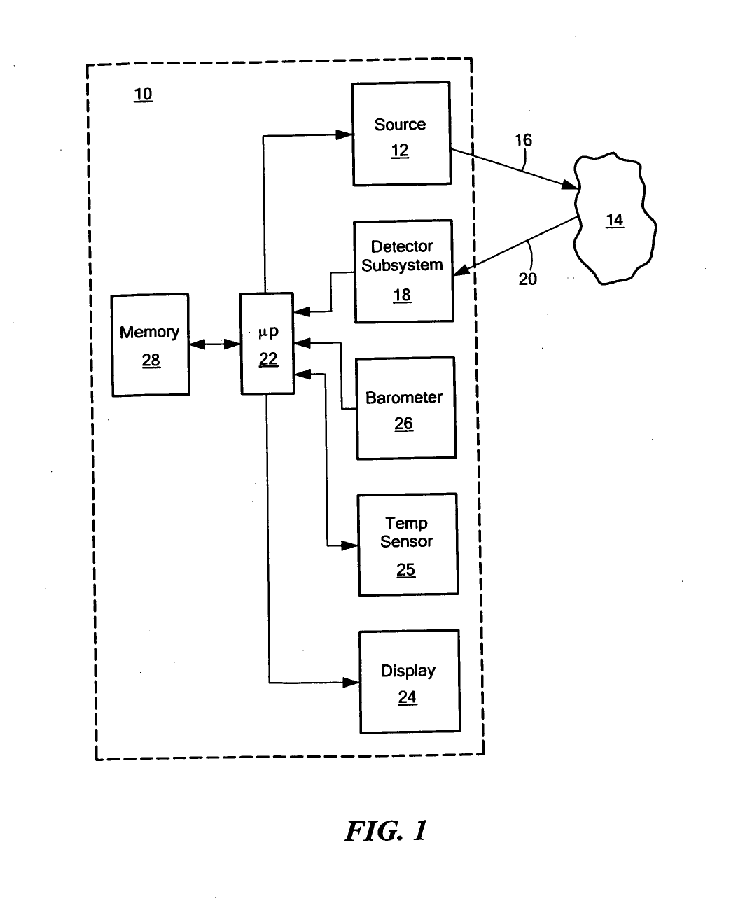

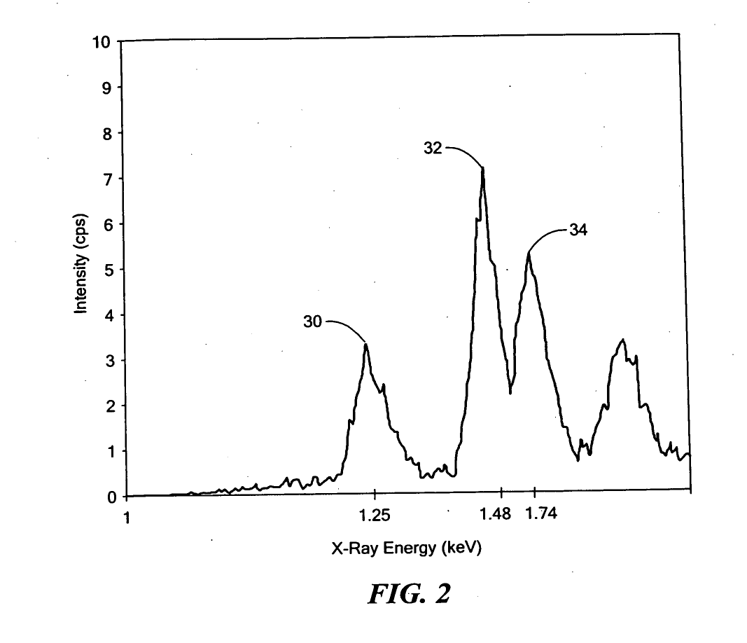

In one example, portable XRF analyzer 10, FIG. 1 includes x-ray source 12 configured to emit x-rays to a sample 14 along first path 16 and also detector subsystem 18 responsive to x-rays radiated by sample 14 detected along second path 20. As is known in the art, detection subsystem 18 (which typically includes one or more detectors such as a silicon drift detector and an analyzer) outputs to processing subsystem 22 the intensity of x-rays detected at different energy levels as shown in FIG. 2. Processing subsystem 22, which may include a processor and related circuitry onboard analyzer 10 and/or a computer program operating on a computer linked to analyzer 10, calculates the concentration of different elements present in sample 14, FIG. 1 based on the known relationship between concentration and the peak intensity shown in FIG. 2 at various energy levels. Peaks 30, 32, and 34, for example, may relate to magnesium, aluminum, and silicon, respectively. The height of the peaks correspond to different relative amounts or concentrations of these elements. In this way, the concentration of these elements in sample 14, FIG. 1 can be displayed on display 24, FIG. 1. A graph similar to the one shown in FIG. 2 may also be displayed.

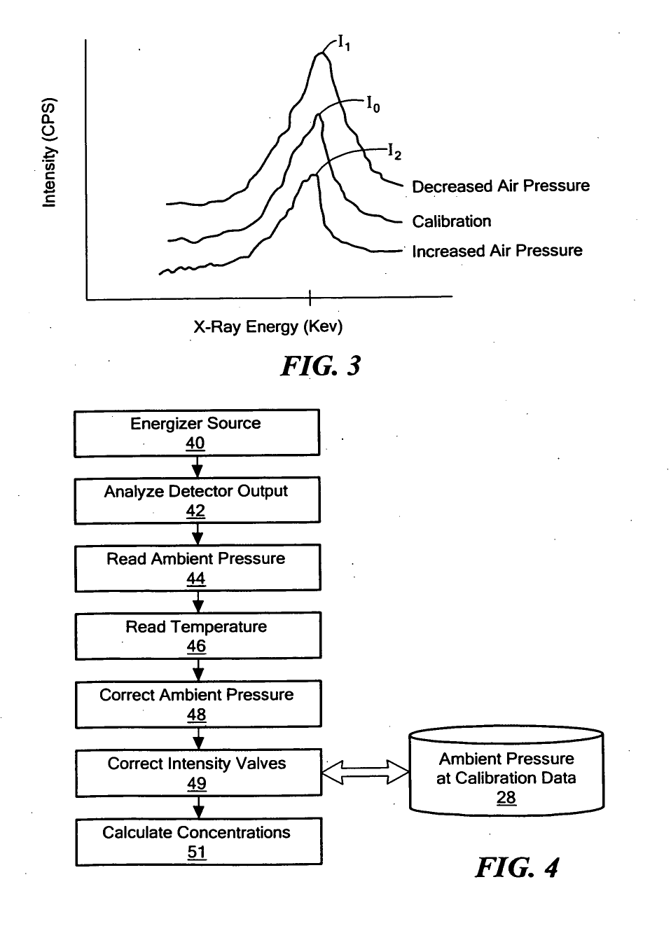

As shown in FIG. 3, at a known pressure P₀ for a known concentration of a given element, the intensity of the fluoresced x-rays detected will be I₀. But, when the analyzer is used at a barometric pressure less than P₀ (at increased elevations, or in a location subject to a low pressure weather system), there are fewer air molecules to absorb fluoresced x-rays especially for low energy x-rays and thus the measured intensity is I₁ which is higher than I₀. Conversely, when the analyzer is used at a barometric pressure greater than P₀ (at decreased elevations, for example, or in locations subject to a high pressure weather system), there are more air molecules absorbing especially low energy x-rays and thus the measured intensity is I₂ which is lower than I₀. Both I₁ and I₂ are incorrect assuming sample 14, FIG. 1 includes the same concentration of the element measured at P₀.

Thus, in accordance with the subject invention, analyzer 10, FIG. 1 includes a pressure measurement device such as barometer 26 disposed to measure the pressure of the atmosphere in or in the proximity of the analyzer which is typically the same as the ambient air pressure present in paths 16 and 20. In one example, barometer 26, FIG. 1 is a low power MEMS barometer model MPL115A manufactured by Freescale Semiconductor. Another is a Bosch barometer BMP085. Temperature sensor 25 is also included to measure the ambient air temperature. Detector subsystem 18 outputs intensity values in counts per second. Processor 22 reads the pressure and temperature values and converts the read pressure (as output by barometer 26) to an effective or corrected pressure based on the temperature. The intensity values are then corrected based on the corrected pressure. The corrected intensity values are then used to calculate concentrations. See, for example, U.S. Publication No. 2007/0269003 incorporated herein by this reference.

Processing subsystem 22 thus corrects a measured concentration based on the pressure output by barometer 26. In one example, memory 28 includes stored calibration data (curves or equations) including, at least for one low atomic number element, an intensity level for a known concentration of the element at a known gas pressure. The processing subsystem 22 is then configured to correct the measured intensity and concentration based on the stored calibration data. In general, when the detector system outputs an intensity I for a known concentration of a given element at a calibrated pressure P₀, the processor subsystem increases the measured concentration when the measured gas pressure is greater than P₀ and decreases the measured concentration when the gas pressure is less than P₀.

Memory 28 may include, for an element as shown in FIG. 3, a known intensity corresponding to a peak value of I₀ at a known calibration pressure P₀. P₀ can be assumed to be standard pressure or the actual pressure at the time and place of calibration. Processing subsystem 22, then, is programmed to compute, for an unknown intensity of that element, the intensity for that element based on or as a function of 1) the measured peak (I₁ or I₂ in the example above), 2) the pressure as measured by barometer 26, FIG. 1, and 3) the intensity value for a known concentration of that element at a known pressure.

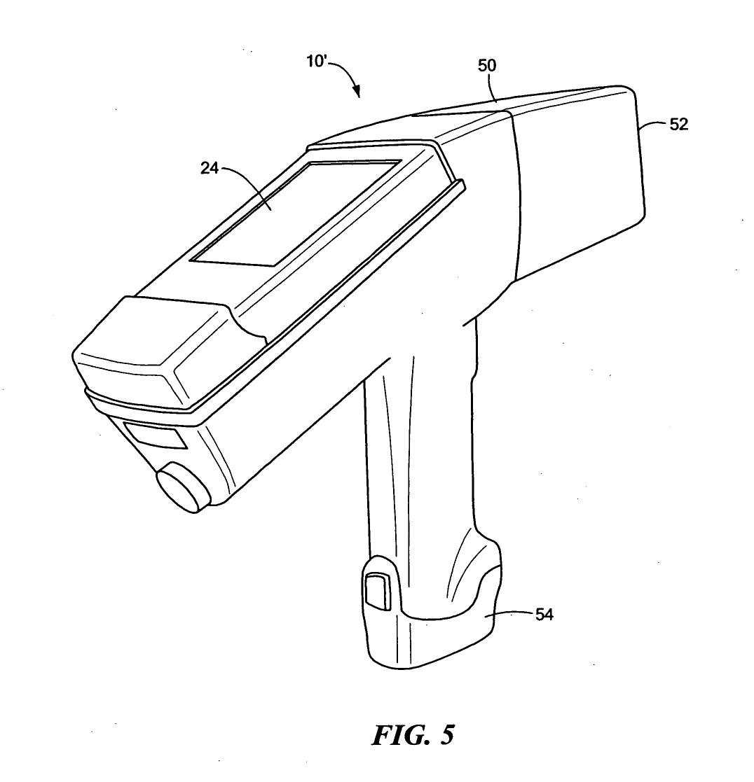

Processing subsystem 22, in one typical embodiment, is configured (e.g., programmed) to energize source 12 upon a command from the user, step 40, FIG. 4. The detector subsystem output is analyzed, step 42. An intensity value in counts per second is measured for an element. The ambient pressure (Pₘ) is automatically read, step 44 from barometer 46, FIG. 1. The temperature (Tₘ) is also read, step 46. The pressure as read from the barometer is then corrected based on the temperature, step 48. The corrected or effective pressure (P_{E}) is:

Pₘ*Tₙₒₘ/Tₘ where Tₙₒₘ=300K. (1)

The corrected pressure is then used to correct the intensity value as output from the detector, step 49, using the data in database 28 (either a curve of intensity versus pressure or an equation for the curve). From the pressure corrected intensity value, the concentration of that element can be calculated, this process is then repeated for preferably all detected elements. The results are then typically displayed. It should be noted that to optimize the instrument's real-time measurement performance, this process need not be applied to all detected elements. Accordingly, it may be applied to only the detected elements of concern (e.g., those with a low atomic number) to minimize processing time.

In one example, the difference between the measurement and standard pressure (1013 mbar) (Pₙₒₘᵢₙₐₗ) is used. The pressure difference (P_{diff}) is:

P_{diff}=Pₙₒₘᵢₙₐₗ−P_{m(corr)} (2)

using this value, the correction factor to apply to the intensity value detected by the device's x-ray detector subsystem is calculated:

correction factor=exp(−C_{E}* Pdiff) (3)

where C_{E} is an empirically determined factor obtained for each element Eᵢ for a known excitation energy Eo. Pdiff=Pₒ−P_{E}. Values of C_{E} greater than 1 results in an increase in intensity and values less than 1 results in decreased intensity.

The corrFactor number can be obtained by processor 22, FIG. 1 from a precalculated lookup table in memory 28 which allows for the optimization of the calculation to a single step. Calibration pressures other than 1013 mbar and 300K can be used if desired.

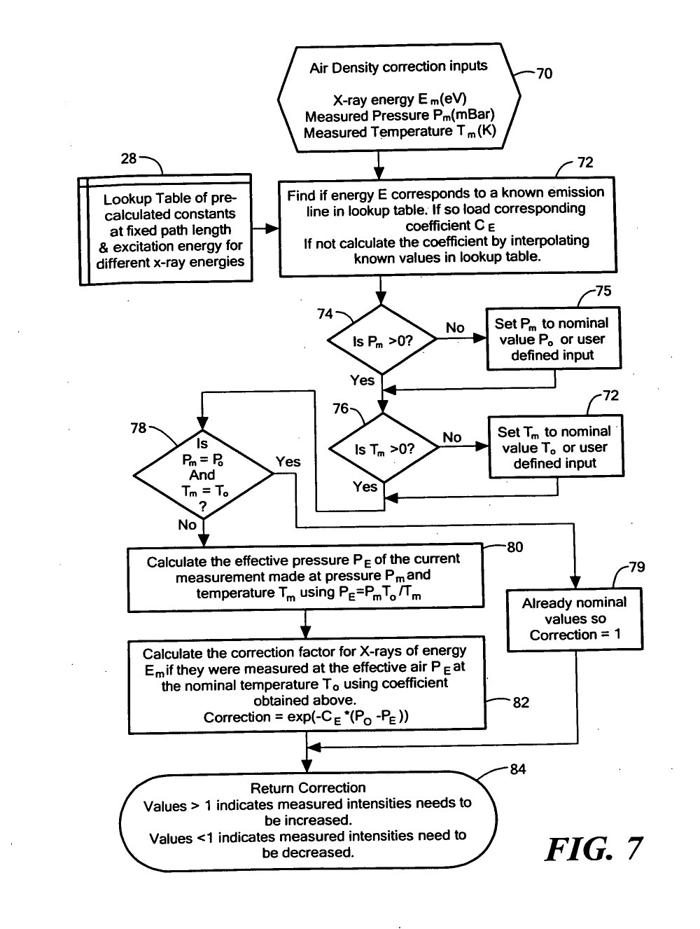

As shown at 70 in FIG. 7, the inputs to the processing subsystem are the x-ray energy Eₘ (from detector subsystem 18, FIG. 1), the measured pressure Pₘ (from barometer 26, FIG. 1), and the measured temperature Tₘ (from temperature sensor 25, FIG. 1). In step 72, correction coefficient C_{E} (see equation 3) is determined for Eₘ using tables stored in database 28, FIG. 1. If C_{E} is not available for a specific x-ray energy Eₘ, then a correction coefficient C_{E} is extrapolated for that specific energy from the values that are stored in the table.

Also, if Pₘ and/or Tₘ are not available for some reason, processing should not cease and so Pₘ and Tₘ can be set to nominal values Pₒ or Tₒ (or they can be user defined inputs), steps 74-78. In one example, Pₒ is standard pressure (1013 mbar) and Tₒ is standard temperature (300K). If these nominal values are used, as shown at step 79, the correction factor (see equation 3) is 1.

In most cases, Pₘ and Tₘ will be available and, in step 80, the effective pressure is calculated as discussed above with reference to equation 1. Step 82 shows how the correction factor is calculated from Pₒ, P_{E}, and C_{E}. Using correction factor returned at step 84, steps 49-51, FIG. 4 are carried out.

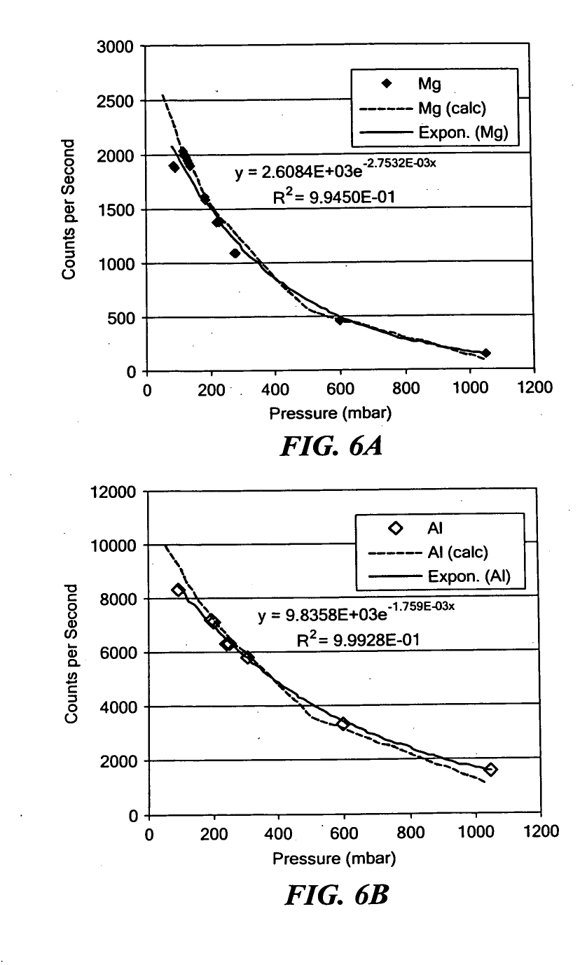

One handheld XRF analyzer 10, FIG. 5 embodying the subject invention includes housing 50 including the components shown in FIG. 1 and barometer 26. Barometer 26 may be mounted on a printed circuit board within analyzer housing 50. There is also typically a window at front end 52 through which the x-rays pass to and from a sample. Display 24 is also shown as is battery compartment 54. Examples of portable handheld XRF analyzers which may include the subject invention include the Delta XRF analyzers offered for sale by the applicant hereof. Ambient air may be allowed to enter housing so in order to measure ambient air pressure and temperature.

In an XRF analyzer, air absorption in the region between the sample, detector and x-ray tube causes a substantial attenuation of the signal for low energy x-rays. If the air pressure in the region changes relative to the air pressure at the time of the factory calibration, the accuracy of the measurement is impacted. The air can attenuate x-rays both from tube to the sample and from the sample to the detector. The amount of attenuation is stronger the lower the energy, so for example magnesium (1.25 keV) will be more heavily affected than aluminum (1.48 keV) or silicon (1.74 keV).

A method for in-field, automatic correction of results based on changing air pressure and temperature is disclosed. One preferred method utilizes a pressure sensor 26, FIG. 1 added to the inside of the XRF analyzer in addition to an existing temperature sensor 25 that is already standard in such analyzers. This information is then used to determine the impact of air absorption as a function of temperature and pressure. The quantity determined as a function of air temperature and pressure is the differential absorption (correction from one pressure and temperature to another). This is given by the equation:

Absorption A(P, T)=exp(−ρ*K(E)/L) (4)

where K is the energy dependent absorption cross section (in cm²/g) evaluated at energy E, and L is the path length from either the sample 14 to the detector 18, or the tube 12 to the sample 14. The value of K and its energy dependence can be obtained from tabulated material data (one example is the program XCOM available from the National Institute of Science and Technology). The only unknown is the quantity p which is the gas density in units of g/cm³. This value is a function of both temperature and pressure, and for this we substitute in the ideal gas law given by:

ρ=P/(RT) (5)

Here P is the pressure in mBar, T is the temperature in Kelvin (absolute), and R is the gas constant expressed in the right choice of units including the molar mass of air. With this substitution for the equation for the absorption as a function of pressure and temperature it becomes:

A(P, T)=exp(−P*K(E)/(RTL)) (6)

The equation for the total absorption in the region between tube, sample and detector, due to air absorption of both source and fluoresced x-rays is below. This is given by the formula below and accounts for the pressure and temperature dependent absorption from source x-rays that travel from the tube towards the sample, and from the fluoresced x-rays that travel from low atomic number elements fluoresced in the sample to the detector:

$$\begin{matrix}A = exp ( - P * K ( {E}_{i } ) / RTLi ) * exp ( - P * K ( {E}_{o} ) / RTLo ) \\ = exp ( - P / T * ( K ( Ei ) / Li - K ( Eo ) / Lo ) * R )\end{matrix} \qquad ( 7 )$$

In the above equation, the following quantities are defined as follows:

E₀=The energy of the incident x-rays in keV. For simplicity assumed to be the average energy of the x-rays from the x-ray source. This assumption may be relaxed at the expense of a more complicated but well known formulation. Other assumptions may also be made.

Eᵢ=The energy of the fluoresced x-ray being detected from element “i.”

L_{T}=The path length from the tube outlet to the sample, in units of cm.

Lₚ=The path length from the sample to the detector in units of cm.

The final form of the correction is based on the difference between the air absorption during analyzer calibration, at known pressure and temperature values P_{c} and T_{c}, and the air absorption that occurs during a given sample measurement at pressure and temperature values Pₘ and Tₘ. This is the equation that is used to calculate the correction to the absorption at different pressure and temperature values compared to the time of calibration:

A(final)=exp−{[Pₘ/Tₘ*(K(Ei)/L_{D}−K(Eo)/L_{T})*R]−[P_{c}/T_{c}*(K(Ei)/L_{D}−K(E₀)/L_{T})*R]} (8)

The correction can further be reduced if all measurements, including calibrations and unknowns are all corrected to a single nominal pressure and temperature, and thus nominal density, at the time of data processing. The temperature can also be expressed as an effective change in pressure which would result in the same density at the nominal temperature.

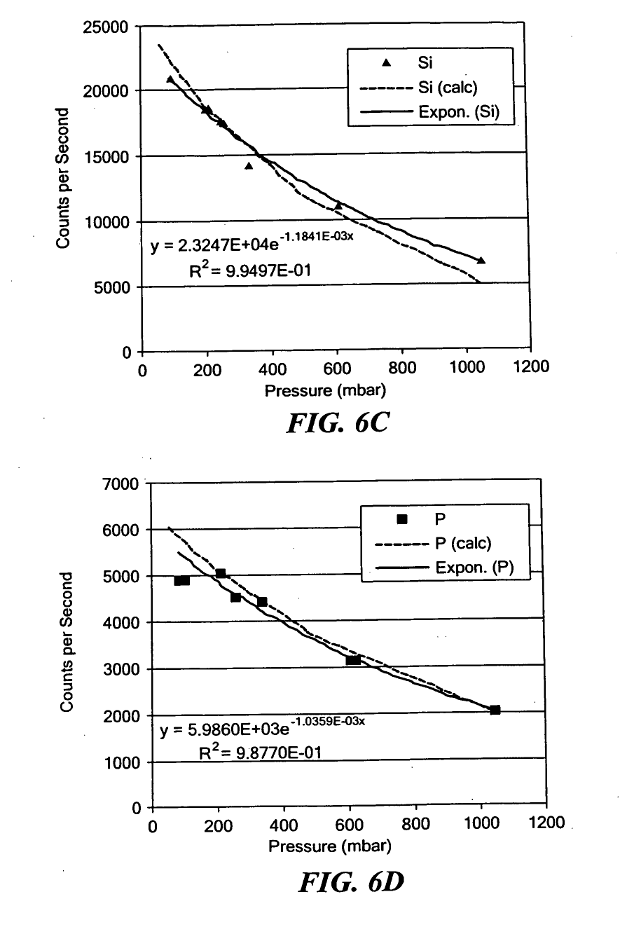

The absorption has been measured and compared to predicted values from the above formulas, as shown in FIG. 6. We first measured the count rates at ambient pressure on pure samples of Mg, Al, Si and P at factory calibration conditions and we refer to these quantities as I_{c}(Mg), I_{c}(Al), I_{c}(Si), I_{c}(P). We then created a vacuum in the region around the sample, tube, and detector down to 100 mbar, and measure the x-ray count rates of Mg, Al, Si and P from the same pure samples at several different values of pressure between 100 mbar and atmospheric pressure. The predicted rates at these various pressures are then given by the product

I_{c}(Mg)*A_{final}(Mg), (9)

Where A_{final}(Mg) is the absorption factor calculated from the above formula, evaluated at the energy of the magnesium K-alpha x-ray energy, at various values of pressure. The predicted rates for Al, Si and P are given by similar equations except that the absorption factors are determined using the energy of the Al, Si or P K-alpha x-ray energies, respectively. The pressure was provided by the internal pressure sensor included with the unit. As shown in FIGS. 6A-6D, the measured intensities at several values of pressure for the four elements Mg, Al, Si and P are sufficiently reproduced by the product of the known rates measured at some ambient pressure I₀ and the absorption factor. The calibration data can be the actual curves or the formulas for the curves.

Assume the detector outputs an intensity of 1000 counts per second for Al (energy level 1.48 keV). The pressure output by the barometer is 100 kPa. The temperature is determined and the pressure of 100 kPa is corrected to 95 kPa based on the temperature. There is at this lower pressure, a 2.16% increased in transmission. The intensity level of 1000 counts is then corrected by 21.6 to 978.4 counts based on a corrected pressure of 950 kPa (1000−1000×21.6%).

In a portable XRF analyzer, the following steps can be executed in order to automatically correct certain elemental results at the time of measurement, due to changes in ambient air pressure, in an example.

The XRF analyzer is factory calibrated for various elements at a known ambient pressure and temperature P_{c} and T_{c} respectively, so that the count rates for these various elements I_{c} (i) for element (i) is known. Practically, this correction need only be applied to the low atomic number elements such as Mg, Al, Si, P and S, but it is recorded for all samples. Thus processor 22, FIG. 1 of the XRF analyzer stores measured element calibration intensities I_{c}(Mg) for Mg, I_{c}(Al) for Al, etc. and also measured values for temperature and pressure T_{c} and P_{c} at time of calibration. Memory 28 contains these values.

During field use, the XRF analyzer measures the count rates of various elements “i” Iₘ(i), and also measures the ambient pressure and temperature values Pₘ and Tₘ with the onboard pressure 26 and temperature 25 sensors.

Processor 22 calculates the absorption factor A_{final}(i) for each element “i” at the new pressure and temperature values Pₘ and Tₘ.

Processor 22 then calculates a correction to the calibration intensities of the pure element count rates for each element of interest from the product Iₘ(i)=I_{c}(i)A_{final}. For example, Iₘ(Mg)=I_{c}(Mg)*A_{final}.

The analyzer uses the new calibration intensity Iₘ (i) in order to calculate a corrected concentration of element “i” that includes the effect of a change in pressure and temperature. This is also done for other elements of interest Al, Si and P for example.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A portable analyzer comprising:
an x-ray source configured to emit x-rays to a sample;
a detector subsystem responsive to x-rays irradiated by the sample and outputting intensities of x-rays detected at different energy levels;
a pressure measurement device disposed to measure the pressure of ambient air;
a processing subsystem responsive to the detector subsystem and the pressure measurement device and configured to:
calculate the concentration of at least one low atomic number element in the sample based on the intensity of the x-rays detected by the detector subsystem at an energy level corresponding to the element including correcting the intensity based on the ambient air pressure.

2. The analyzer of claim 1 in which the detector subsystem outputs an intensity I for a known concentration of said element at a calibrated pressure P_{c} and the processing subsystem increases the intensity when the gas pressure is greater than P_{c} and decreases the intensity when the gas pressure is less than P_{c}.

3. The analyzer of claim 1 further including stored calibration data including at least, for one low atomic number element, intensity levels for a known concentration of the element at different gas pressures.

4. The analyzer of claim 3 in which the processing subsystem is configured to correct the measured intensity based on the stored calibration data.

5. The analyzer of claim 4 in which the processing subsystem is configured to calculate an absorption factor for an element at the measured pressure.

6. The analyzer of claim 1 in which the detector subsystem includes a silicon drift detector.

7. The analyzer of claim 1 in which the pressure measurement device is a barometer.

8. The analyzer of claim 1 further including a temperature sensor for measuring ambient air temperature.

9. The analyzer of claim 8 in which the processor is further configured to correct the pressure based on the temperature and to correct the intensity based on the corrected pressure.

10. The analyzer of claim 9 in which the processor is configured to correct the measured pressure based on the measured temperature by correcting the measured pressure based on the measured temperature and a calibration temperature.

11. The analyzer of claim 9 in which the processor is configured to correct the intensity by determining a difference between the corrected pressure and a calibration pressure and using the difference to correct the intensity.

12. The analyzer of claim 11 in which the processor is configured to correct the intensity by determining a correction factor which is a function of a constant and the difference between the corrected pressure and a calibration pressure.

13. The method of claim 12 in which the correction factor for each element is empirically determined for a known excitation energy.

14. The analyzer of claim 1 further including a housing about the x-ray source and the detector subsystem, the housing including a window through which the x-rays pass to and from the sample.

15. The analyzer of claim 14 in which the pressure measurement device is disposed in the housing.

16. An XRF analysis method comprising:
emitting x-rays to a sample;
detecting x-rays irradiated by the sample and measuring the intensities of x-rays detected at different energy levels;
measuring the pressure of ambient air;
automatically calculating a concentration of at least one element in the sample based on the intensity of the x-rays detected at an energy level corresponding to the element including automatically correcting the intensity based on the ambient air pressure.

17. The method of claim 16 in which for an intensity I measured for a known concentration of said element at a calibrated pressure P_{c}, correcting includes increasing the intensity when the gas pressure is greater than P_{c} and decreasing the intensity when the gas pressure is less than P_{c}.

18. The method of claim 16 further including storing calibration data including at least, for one element, intensity levels for a known concentration of the element at different gas pressures.

19. The method of claim 18 in which correcting the intensity includes basing the correction on the stored calibration data.

20. The method of claim 16 further including measuring ambient air temperature, correcting the measured pressure based on the measured temperature, and correcting the intensity based on the corrected pressure.

21. The method of claim 20 in which correcting the measured pressure based on the measured temperature includes correcting the measured pressure based on the measured temperature and a calibration temperature.

22. The method of claim 20 in which correcting the intensity includes determining a difference between the corrected pressure and a calibration pressure and using the difference to correct the intensity.

23. The method of claim 22 in which correcting the intensity includes determining a correction factor which is a function of a constant and the difference between the corrected pressure and a calibration pressure.

24. The method of claim 23 in which the correction factor for each element is empirically determined for a known excitation energy.

25. An XRF analysis method comprising:
using an XRF analyzer to induce fluorescence in a calibration sample with a known concentration of an element at a calibration pressure and temperature;
detecting said fluorescence and storing count rates for said element at the calibration pressure and temperature in the XRF analyzer;
using the XRF analyzer to induce fluorescence in a field sample with an unknown concentration of said element at an ambient pressure and temperature;
detecting said fluorescence and determining a count rate for said element;
measuring the ambient pressure and temperature; and
correcting the determined count rate based on the ambient pressure and temperature and the stored count rates for the element at the calibration pressures and temperatures.
